(19) United States
(12) Patent Application Publication
(10) Pub. No.: US 2005/0193651 A1
(43) Pub. Date: Sep. 8, 2005

(54) Shutter assembly for storm and security protection

(76) Inventor: Cameron Kirk, Elgin, IL (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/070,619

(22) Filed: Mar. 2, 2005

Related U.S. Application Data
(60) Provisional application No. 60/551,188, filed on Mar. 8, 2004.
(60) Provisional application No. 60/585,211, filed on Jul. 2, 2004.

(51) Int. Cl. E06B 3/26

(52) U.S. Cl. 52/202

(57) ABSTRACT

A shutter assembly for storm and security protection is disclosed. The shutter assembly mounts to a structure adjacent an opening in the structure. The assembly may include a mounting system comprising inserts for mounting into the structure, fasteners formed from a non-corrosive material inserted into the inserts, and plugs for insertion into the inserts to conceal the inserts within the structure. A protective element is positioned in a plane offset from the opening for protecting the opening from debris. A housing is positioned adjacent the opening and defines a cavity for housing the protective element therein. The housing is surface mounted to the structure such that the housing requires no major damage to the existing wall surface. A decorative shutter mounts to the housing for concealing the cavity and for improving aesthetics of the structure.

### CROSS REFERENCE TO RELATED APPLICATION

This application claims the benefit of Provisional Application Ser. Nos. 60/551,188 and 60/585,211 filed Mar. 8, 2004 and Jul. 2, 2004, respectively.

### BACKGROUND OF THE INVENTION

1. Field of the Invention

The subject invention relates to a shutter assembly, and more specifically to a shutter assembly for providing storm and security protection, especially hurricane protection.

2. Description of the Related Art

Shutters generally are either functional or decorative and decorative shutters are generally for aesthetic purposes only. The decorative shutters are fastened directly to an exterior wall adjacent a window and typically the width of the decorative shutters are not sufficient to traverse the full width of the window. Functional shutters are generally moveable between an open position adjacent the window and a closed position covering the window. When the functional shutters cover the window, the aesthetic appearance of the building suffers because the shutters are no longer adjacent the windows. Further, these functional shutters are typically made of lightweight material that does not provide adequate strength for protection in storms.

Such decorative functional shutters are usually used for decorative purposes only and are generally not storm rated, i.e., the shutter does not provide adequate protection in a storm. In order for the shutters to be functional, expensive hinges, hardware and fastening systems must be purchased to incorporate the functionality. Further, in order to be aesthetically appealing, the shutters must be proportionate to the size of the window opening and each shutter must cover exactly half of the opening. When closed, the shutters must meet perfectly in the middle to cover the opening. Therefore, no shutter can be wider than 20″ to 24″ and still retain an aesthetically desirable appearance.

Since the shutters must be decorative and functional and because most foundations settle and the openings are out of square or irregularly shaped windows, the shutters are typically professionally measured, custom manufactured, and professionally installed. The custom manufacturing results in the shutters being very expensive, while only providing limited security function.

Storm panels, e.g., wood or plywood panels may be used to cover or protect windows during severe weather. These storm panels are typically non-decorative and do not allow light into the structure. The panels prevent debris from hitting and breaking the windows. Typically, the panels are large and must be manually fastened to the window frame by screws or nails. When there is no severe weather, the panel must be stored elsewhere, e.g., a storage shed or garage and must be located, moved, and secured into place prior to a storm. It is cumbersome and time intensive to mount these storm panels as the storm is approaching. It is also impractical to leave the storms panels mounted year round because the storm panels decrease the aesthetic appearance of the building. Another disadvantage is that these related art storm panels are very hard to install, especially on second story applications.

Installation of the storm panels typically require a top track that must be secured to the wall and a bottom track that must be secured to the wall. However, the storm panels may be directly fastened to the structure without tracks which is also undesirable. Multiple vertical or horizontal panels are then interlocked to span the opening. The panels are heavy, awkward, and cumbersome to handle. Further, the edges of the panels are often sharp and the panels become slippery to handle when wet. Such panels also require heavy-duty fasteners to properly affix to the wall. When installed, these fasteners damage the surface of the wall and leave unsightly holes when removed.

Other related art assemblies incorporate large metal or reinforced vinyl storm panels that are housed in large boxes either above the window or to the side, commonly referred to as accordion or roll down shutters. These metal storm panels are extended when a storm approaches. However, these large boxes are unsightly blemishes on the buildings. The roll down shutters are operated manually, mechanically with a crank or motor, or electronically with a switch or remote control. These shutters are non-decorative, but are self-storing within the boxes. Because the boxes are visible from the outside, many residential communities have “aesthetic compliance codes” and these shutters are banned.

Another disadvantage of such shutters is that professional measurements are required to fit the exact size of the opening and are typically custom manufactured to adjust for any irregularities, out of square openings, or irregularities in the structure. Because of the custom nature of these shutters, manufacturing such shutter are very expensive and may take up to 4-6 weeks, or longer in hurricane season, to manufacture them.

Security protection has been provided to buildings by mounting metal bars in the windows. While these bars are effective at keeping intruders out of the house, the bars prevent occupants from exiting through the window. If an emergency develops that requires the occupants to exit the structure, the bars do not facilitate such an escape. Further, these or similar security measures decrease the aesthetic appearance of the buildings.

The related art assemblies are characterized by one or more inadequacies. Accordingly, it would be advantageous to provide a shutter assembly that may both be used to protect openings within the structure and to provide an improved aesthetic appearance. It would also be advantageous to provide an assembly that may remain mounted to the building to provide storm and security protection that is easily opened and closed from within the structure, while remaining locked to intruders outside the structure.

### SUMMARY OF THE INVENTION AND ADVANTAGES

The subject invention provides a shutter assembly and a protection system for mounting to a structure adjacent an opening in the structure. The assembly includes a mounting system comprising inserts for mounting into the structure, fasteners formed from a non-corrosive material inserted into the inserts, and plugs for insertion into the inserts to conceal the inserts within the structure. A protective element is positioned in a plane offset from the opening for protecting the opening from debris.

In one embodiment of the subject invention, the shutter assembly includes a pair of housings each defining a cavity therein opposite one another for mounting to the structure adjacent the opening. The protective element is housed within at least one of the cavities and a pair of decorative shutters each mount to the respective housings for concealing the cavity and for providing an aesthetic appearance to the structure. The protective element is extendable from the housing to cover the opening for providing storm and security protection.

In another embodiment, the shutter assembly includes upper and lower tracks each defining a channel and holes therein that is fastened to the structure with the mounting system. The protective element is received in the upper and the lower tracks for protecting the opening from debris. The decorative shutters are secured with the fasteners to the inserts for mounting adjacent the opening to provide an aesthetic appearance to the structure.

The subject invention overcomes the inadequacies that characterize the related art invention. Specifically, the subject invention provides storm and security protection while also improving the aesthetic appearance of the structure. The shutter assembly may remain installed to the structure outside of storm season and therefore requires no additional time or labor to take it down and reinstall it. The subject invention also reduces any likelihood of being injured when repeatedly installing and dismantling the shutter assembly. The shutter assembly is also relatively lightweight and can be adapted for various openings and for different structures.

Another advantage of the subject invention is that the shutter assembly can be applied to an existing structure and have the necessary protective elements to substantially cover the size of the opening with little or no custom measuring or manufacturing. Since the subject invention does not require custom manufacturing, the manufacturing costs are less than cost to manufacture the customized shutter assemblies. Still another advantage is that the protective elements of the subject invention may be employed to cover any sized opening, whereas the related art decorative functional shutters are limited in size.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an environmental view of a structure having openings with shutter assemblies mounted thereto;

FIG. 2A is an exploded perspective view of a mounting system;

FIG. 2B is an exploded perspective view of an alternate embodiment of the mounting system;

FIG. 3 is an exploded perspective view of one embodiment of a protective element for securing to the structure;

FIG. 4 is an exploded cross-sectional view of the mounting system securing the protective element to the structure;

FIG. 5 is an exploded perspective view of another embodiment of an upper track and a lower track for supporting the protective element;

FIG. 6 is an exploded perspective view of the shutter assembly of FIG. 5 including a decorative header and a decorative sill for improving the aesthetic appearance of the shutter assembly;

FIG. 7 is an exploded perspective view of still another shutter assembly having an integral decorative header and decorative sill with tracks;

FIG. 8 is an exploded perspective view of the shutter assembly having a concealing strip for increasing the aesthetic appearance of the shutter assembly;

FIG. 9 is an exploded perspective view of yet another embodiment of the shutter assembly having decorative shutters mounted to the structure;

FIG. 10 is an exploded perspective view of the shutter assembly having decorative shutters and an integral decorative header and sill and tracks;

FIG. 11 is a perspective view of yet still another embodiment of the shutter assembly having a protective element as panels extending from a housing mounted to various facades;

FIG. 12 is a perspective view of a shutter assembly having protective decorative bars extending from the housing;

FIGS. 13A and 13B are perspective views of a shutter assembly having a fixed track system for extending the protective panels and having transparent panels;

FIG. 13C is a perspective view of a shutter assembly having removable tracks in the sill and incorporated into the window header;

FIGS. 14 to 16 are perspective views of yet still another embodiment of the shutter assembly having a protective element as panels extending from a housing mounted to various facades;

FIG. 17A is a front perspective view of the shutter assembly having a metal grid as the protective element;

FIG. 17B is a rear perspective view of the shutter assembly shown in FIG. 17A;

FIG. 18 is a side view of alternate perforated metals that may be used as the protective element;

FIG. 19 is a side view of alternate decorative metal that may be used as the protective element;

FIG. 20 is a perspective cross-sectional view of one protective element;

FIG. 21 is a perspective view of a housing for mounting to the structure and for concealing the protective element therein;

FIG. 22 is an exploded perspective cross-sectional view of the housing having the protective element housed therein and a decorative shutter connected thereto;

FIG. 23 is a close-up view of the protective element comprising a first leaf and a second leaf extending from the housing;

FIG. 24 is a perspective view of an alternate embodiment of the protective element comprising a first leaf and a second leaf;

FIGS. 25-28 are perspective views of yet still another embodiment of the shutter assembly having a protective element as a screen extending from a housing mounted to various facades;

FIG. 29 is a perspective view of a housing for mounting to the structure and for concealing the protective element therein;

FIG. 30 is an exploded perspective view of the shutter assembly illustrated in FIGS. 25-28;

FIGS. 31A and 31B are perspective views of a reel mechanism for engaging the protective element;

FIG. 32 is a close-up view of the decorative shutter engaging the housing; and

FIG. 33 is a perspective view of the decorative shutter and the housing formed as a unitary structure.

### DETAILED DESCRIPTION OF THE INVENTION

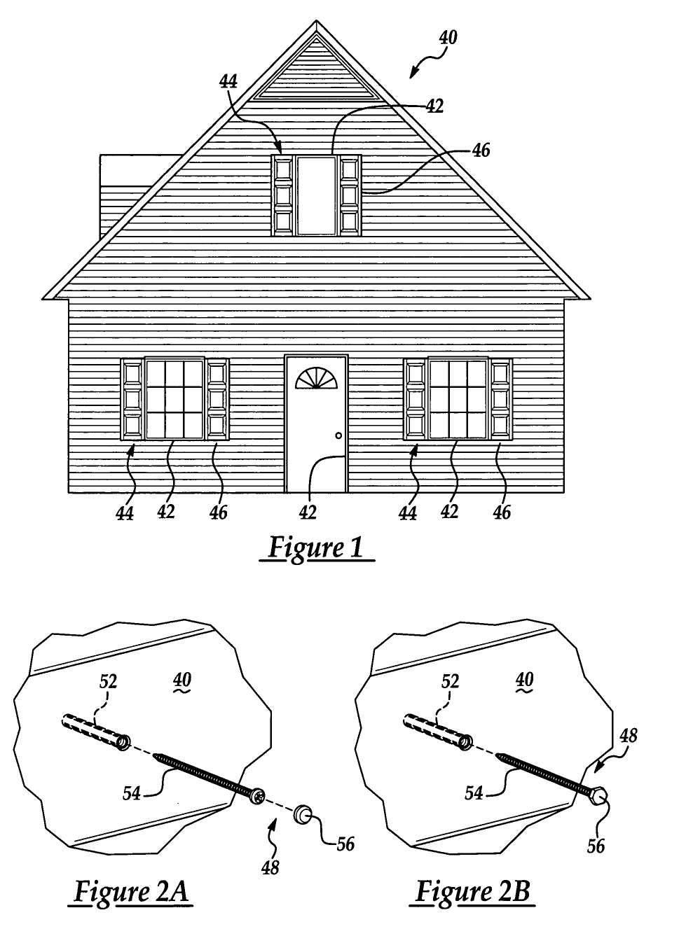

With reference to FIG. 1, an exterior front view of a structure 40, such as a house, that includes openings 42 therein, such as doors and windows, is illustrated. More specifically, the structure 40 includes a door with two first story windows positioned on opposite sides and a second story window. Shutter assemblies 44 are illustrated positioned about the openings 42 and each shutter assembly 44 includes two decorative shutters 46. The decorative shutters 46 may be formed to have an appearance of any type of shutter, such as louvered shutters or panel shutters. Further, the decorative shutter 46 may any type of decorative exterior window treatment that enhances the appearance of the structure, such as lattice, trellis, or woven panels. The shutter assemblies 44 may be rigidly secured to the structure 40 by appropriate securing devices, as will be described below, at a location that aesthetically accents the openings 42. The shutter assemblies 44 provide storm and security protection to the opening 42 and are more specifically a system for hurricane protection. However, certain embodiments of the shutter assembly may be directed to either storm or security protection or both. Those skilled in the art will appreciate that hurricane protection requires an ability to withstand greater wind and load forces than may be encountered or that is necessary for security protection.

In a first embodiment of the subject invention, a shutter assembly 244 for storm protection generally comprises a mounting system 48 and a protective element 50. Referring to FIGS. 2A and 2B, the mounting system 48 includes inserts 52, fasteners 54, and plugs 56. The insert 52 mounts into the structure 40 and may remain within the structure 40 independent of the protective element 50 being mounted thereto, such as when the protective element 50 is no longer needed. The inserts 52 may be threaded or expandable or both for securing into the structure 40. If the insert 52 is threaded, then the insert 52 may be screwed into the structure 40 into a pre-drilled hole or screwed directly into the structure 40. If the insert 52 is expandable, then the insert 52 may be inserted into a pre-drilled hole and the insert 52 will expand when the fastener 54 is inserted therein.

Since the mounting system 48 may remain on the structure 40 even when the protective element 50 is removed, the fasteners 54 are preferably formed from a non-corrosive material, such as vinyl coated metals, stainless steel, vinyl, and the like. The plugs 56 are inserted into the inserts 52 to conceal the inserts 52 within the structure 40. The plugs 56 are preferably colored or paintable to match the aesthetic appearance of the structure 40. The plugs 56 and the fasteners 54 may be integrally formed or separately formed. One example of an integrally formed plug 56 and fastener 54 is illustrated in FIG. 2B having the fastener 54 as a screw with a hexagonal head as the plug 56 that becomes recessed within the insert 52. Alternatively, the plug 56 may snap onto the fastener 54 instead of being recessed within the insert 52.

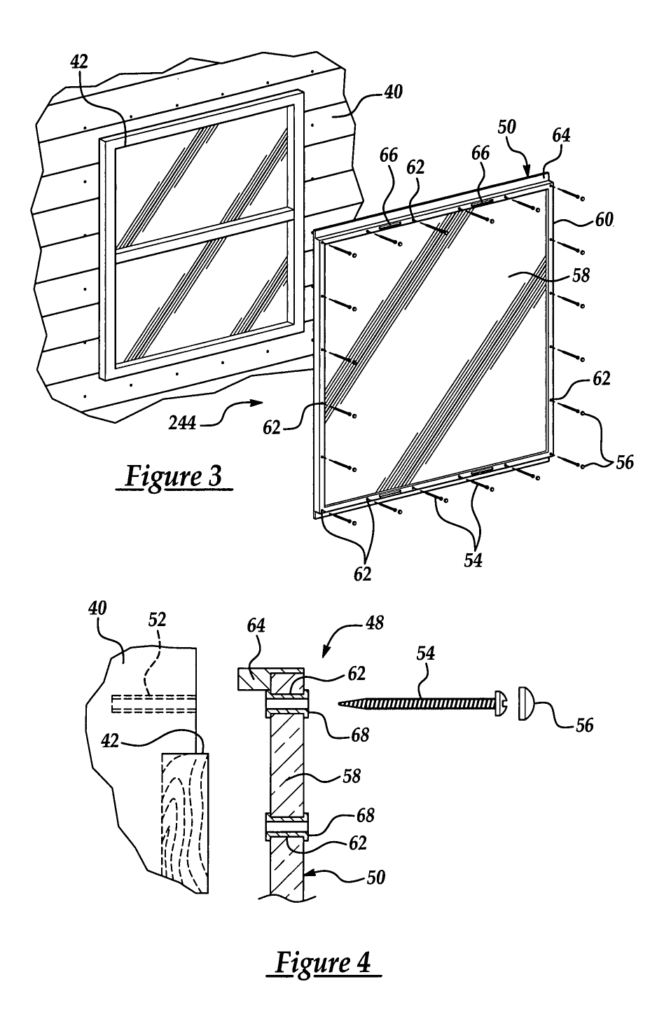

Referring now to FIGS. 3 and 4, the protective element 50 is positioned in a plane offset from the opening 42. The protective element 50 protects the opening 42 from such items as debris, hail, water, wind, or the like. The protective element 50 is selected having a width sufficient for enclosing the opening 42. It is to be appreciated that the protective element 50 may be made of various materials, such as, but not limited to, storm panels, screen mechanisms, KEVLAR®, security bars, shatterproof glass, film-based materials, reinforced vinyl, plywood, or the like. The protective element 50 may also be translucent or opaque depending upon the type of protective element 50 desired. The protective element 50 may be formed from a single element or a plurality of elements depending upon the particular embodiment of the subject invention.

Referring to the embodiment shown in FIG. 3, the protective element 50 is a single panel 58 of a thermoplastic material. In this embodiment, the panel 58 is preferably formed from a polycarbonate material that is translucent to allow light to pass through the protective element 50. The protective element 50 has an outer periphery 60 defining apertures 62 for receiving the fasteners 54. The apertures 62 are spaced a distance apart about the outer periphery 60 to meet the necessary codes and regulations for the particular location. For example, the apertures 62 may be spaced every six inches or every eight inches depending upon the location and the local requirements.

The protective element 50 also includes a frame 64 extending about the outer periphery 60 and inward from a plane of the protective element 50 for contacting the structure 40 and for creating a seal about the opening 42. The frame 64 allows the protective element 50 to fit easily over flush window openings and to be secured to openings 42 that have windows with raised sills without damaging the sills. The frame 64 has a vent 66 for releasing pressure between the protective element 50 and the opening 42. During storms, changes in pressure and temperature may damage either the protective element 50 or the window in the opening 42. Therefore, the vent 66 releases pressure thereby decreasing the likelihood of such damage occurring during the storm. It is to be understood by those skilled in the art that the frame may be manufactured without the vent without deviating from the subject invention.

FIG. 4 is an exploded cross-sectional view of the mounting system 48 including a sleeve 68 inserted into at least one of the apertures 62 for absorbing tension when the fasteners 54 are secured to the inserts 52. The sleeve 68 is preferably formed from a compressible material, such as a rubber, plastic, or vinyl grommet. The compressible material may also include a metal collar or sleeve that is deformable to absorb the compressive force when fastened. The plug 56 would then be received within the grommet when the protective element 50 is fastened to the structure 40. When the protective element 50 is removed, the plug 56 would again be received within the insert 52 until the next time the protective element 50 is fastened to the structure 40.

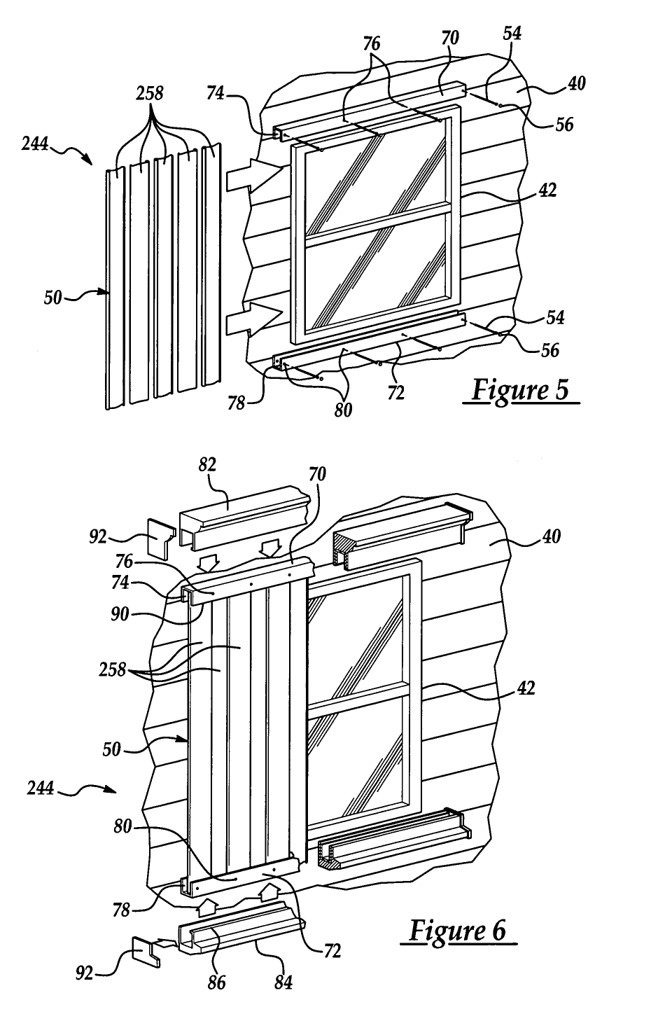

Referring to the embodiment illustrated in FIG. 5 to 8, the shutter assembly 244 also includes an upper track 70 and a lower track 72 for receiving the protective element 50. The upper track 70 defines an upper channel 74 and upper holes 76 therein for mounting to the structure 40 above the opening 42. The lower track 72 also defines a lower channel 78 and lower holes 80 therein for mounting to the structure 40 below the opening 42. The tracks 70, 72 are preferably formed from a lightweight material, such as, but not limited to, plastic or aluminum.

As specifically illustrated in FIG. 5, the upper track 70 and the lower track 72 are mounted to the structure 40 utilizing the mounting system 48 described above. The protective element 50 is illustrated as a plurality of panels 258 that are slidably received within the tracks 70, 72. The plurality of panels 258 interlock with the next adjacent panel in order to provide sufficient strength and protection. Installation of the shutter assembly 244 may involve drilling holes in the structure 40, inserting the inserts 52 into these holes, placing the tracks 70, 72 relative to the inserts 52, and fastening the fastener 54 into the inserts 52.

To remove the shutter assembly 244, the plugs 56 are removed and the fasteners 54 unscrewed. The tracks 70, 72 can be stored until they need to be reinstalled. The fasteners 54 are reinstalled into the inserts 52 and the plug 56 is snapped over the fastener 54 for storage. The mounting system 48 will remain stored in the structure 40 until it is needed again. This allows the customer to quickly reinstall the shutter assembly 244 as needed. The mounting system 48 eliminates the need to repair the structure surface after each installation and it also eliminates the likelihood of misplacing the installation hardware during storage.

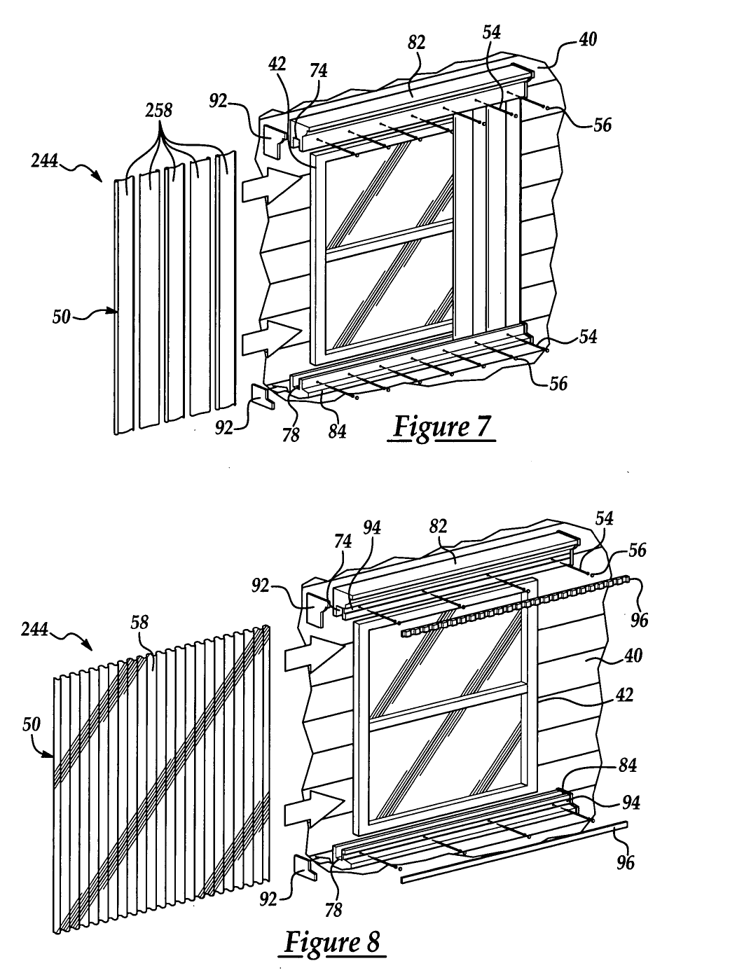

With reference to FIGS. 6 and 7, the upper and the lower tracks 70, 72 are concealed by a decorative header 82 and a decorative sill 84 for improving an aesthetic appearance of the structure 40. In FIG. 6, the decorative header 82 and the decorative sill 84 have a snap-fit connection with the tracks 70, 72. In other words, the decorative header 82 and the decorative sill 84 each have a flange 86 that engages the tracks 70, 72 to create the snap-fit connection thereto. It is to be appreciated that the fasteners 54 may be used to secure the decorative header 82 and the decorative sill 84 to the tracks 70, 72 instead of the snap-fit connection. The decorative header 82 or sill 84 may be made of vinyl, plastic or a hybrid material. The tracks 70, 72 may define a void 88 for receiving the flange 86 or the flange 86 may simply snap over an existing edge 90 of the tracks 70, 72. In order to secure the protective element 50 within the tracks 70, 72, an end cap 92 mounts to an end of each of the decorative header 82 and the decorative sill 84. Each of the decorative header 82 and the decorative sill 84 may require one or two end caps 92. If only one end cap 92 is required, then the opposite end of the decorative header 82 or sill 84 may be closed, whereas if two end caps 92 are required, then both ends are open.

Referring to FIG. 7, the decorative header 82 and the decorative sill 84 may further include holes that align with the upper and lower holes 76, 80 of the tracks 70, 72 for securing to the structure 40. It is to be appreciated that the protective element 50 may also be secured to the structure 40 with the mounting system 48, such as through the decorative header 82 or the decorative sill 84 and the tracks 70, 72. The decorative header 82 and the decorative sill 84, as illustrated in FIG. 7, preferably have the tracks 70, 72 integrally formed with the decorative header 82 and the decorative sill 84.

Another embodiment of the decorative header 82 and the decorative sill 84 is illustrated in FIG. 8 defining a slot 94 therein for receiving the fasteners 54. A concealing strip 96 is mounted within the slot 94 to conceal the fasteners 54 and/or the holes that received the fasteners 54. Preferably, the concealing strip 96 has a snap-fit connection with the slot 94 such that the concealing strip 96 may be easily removed for taking down the protective element 50. The concealing strip 96 may also include a decorative pattern for improving the aesthetic appearance of the structure 40.

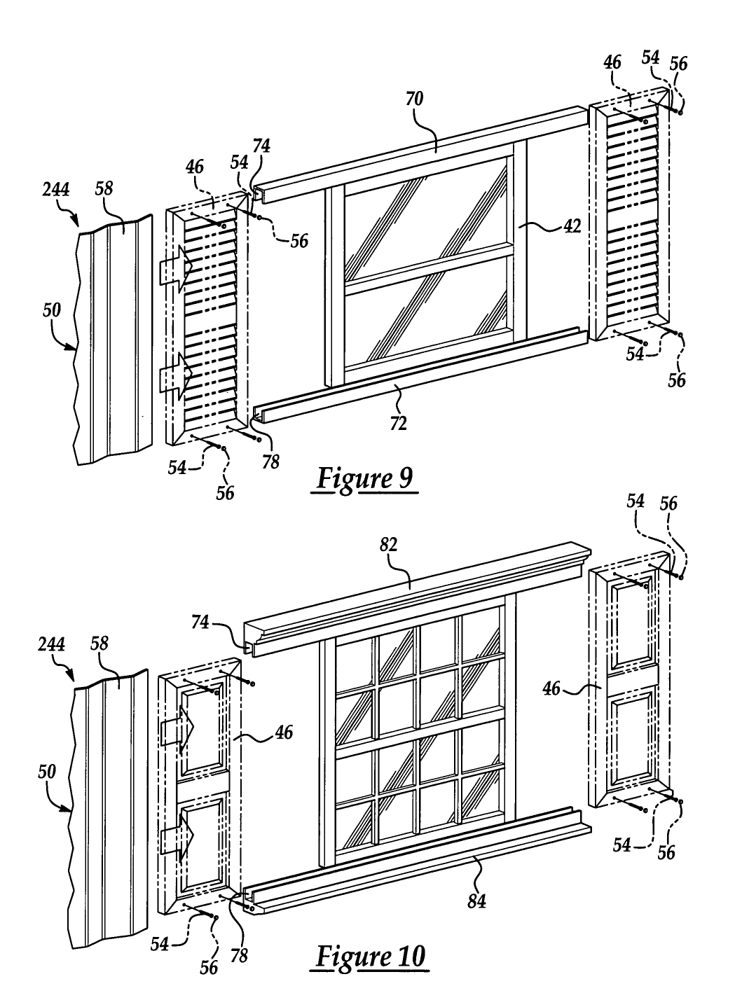

Referring to FIGS. 9 and 10, the pair of decorative shutters 46 is secured with the mounting system 48 to the structure 40. More specifically, the fasteners 54 are inserted through the shutters 46 and into the inserts 52 for securing the shutters 46 adjacent the opening 42. The subject invention provides the ability to have storm and security protection while also providing an aesthetic appearance to the structure 40. Once the tracks 70, 72 are mounted to the structure 40 via the mounting system 48, the protective element 50 is positioned in a plane offset from the opening 42 within the tracks 70, 72 and the shutters 46 are secured to the structure 40. FIG. 9 illustrates the shutters 46 mounted adjacent the tracks 70, 72 without the decorative header 82 or the decorative sill 84. FIG. 10 illustrates the decorative header 82 and the decorative sill 84 having the tracks 70, 72 integrally formed therein.

For installation, the customer removes the decorative shutters 46 and installs the tracks 70, 72 with the same hardware in the same holes. The length is cut to match the span between the installation holes for the decorative shutters 46. This is quicker, easier, and is a major aesthetic improvement over the existing methods of installation. It is also safer, as these installations are often done when high winds, rain, and lightening are approaching and as this work is often being done in second story applications on a ladder. The quicker and easier the installation at this time, the less likelihood there is for injury. If an aluminum ladder was previously used, the subject invention lessens the risk of lightening strikes and electrocution.

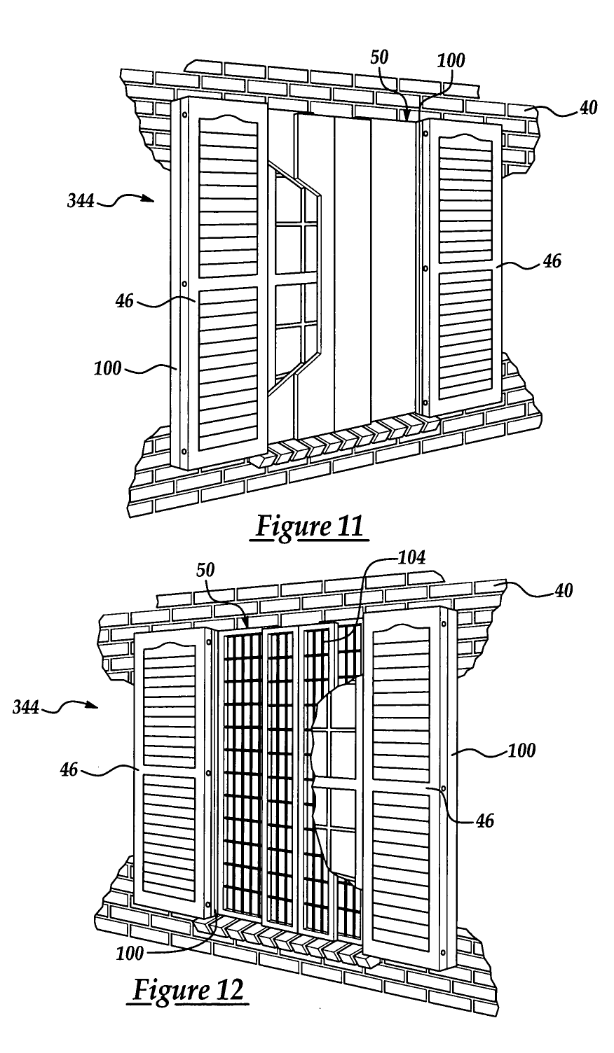

Another embodiment of the subject invention is illustrated in FIGS. 11 to 16. A shutter assembly 344 of this embodiment includes a pair of housings 100 mounted opposite one another and adjacent to the opening 42 for storing the protective element 50 therein. Housing 100 is surface-mounted to the structure 40 and does not require any significant reconstruction of the structure 40. The fastening of the housing 100 to the structure 40 does not cause major damage to the structure so that existing structures may be retrofit with the shutter assembly 344. The housings 100 may be fastened to the structure with the mounting system described above or with any other fastening method known to those skilled in the art.

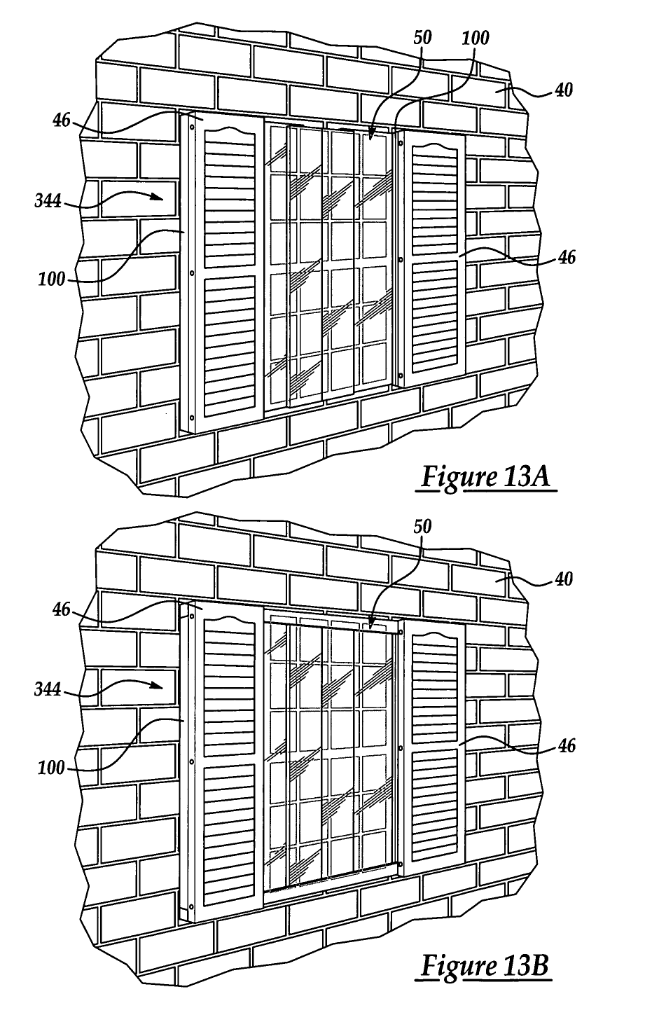

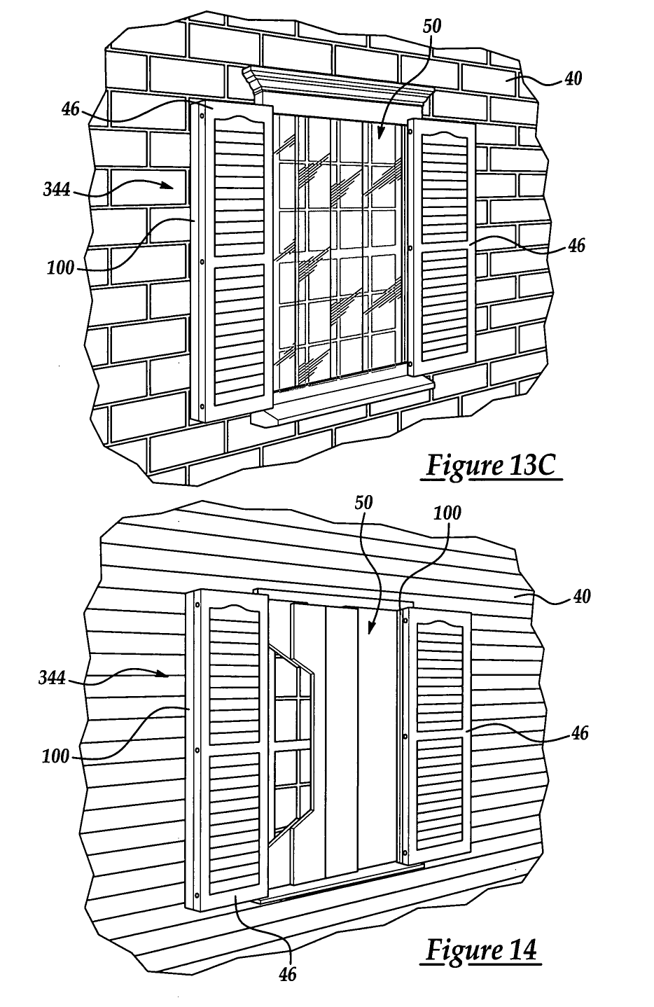

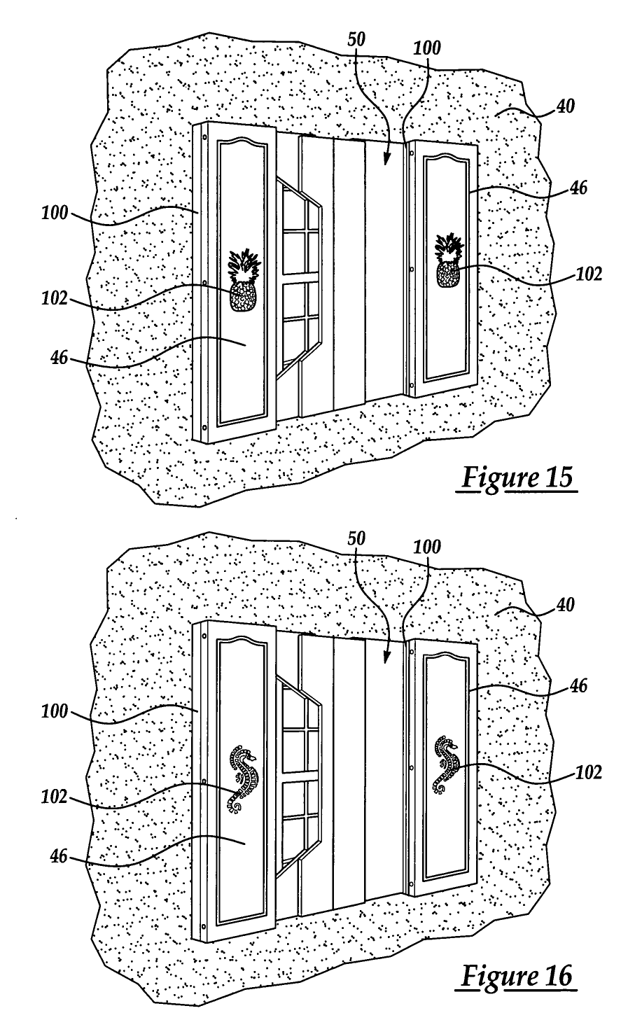

The protective element 50 is moveable into and out of the housing 100 for enclosing the opening 42. FIGS. 11 and 12 illustrates the shutter assembly 344 mounted to a brick-facade structure with the protective element 50 illustrated as solid panels in FIG. 11 and as safety-bar panels in FIG. 12. FIG. 13A illustrates the shutter assembly 344 mounted to a concrete block-facade structure and the protective element 50 is illustrated as solid panels. FIG. 13B illustrates the shutter assembly including upper and lower tracks with the protective element being translucent and FIG. 13C has a decorative header with the track therein and the translucent protective element. FIG. 14 illustrates the shutter assembly 344 mounted to a siding-facade structure with trim abutting the assembly and the protective element 50 is illustrated as solid panels. FIGS. 15 and 16 illustrate the shutter assembly 344 mounted to a stucco-facade structure and the protective element 50 is illustrated as solid panels. The decorative shutters 46 include indicia 102, such as, but not limited to, pineapples or sea horses, for improving the aesthetic appearance of the shutter assembly 344.

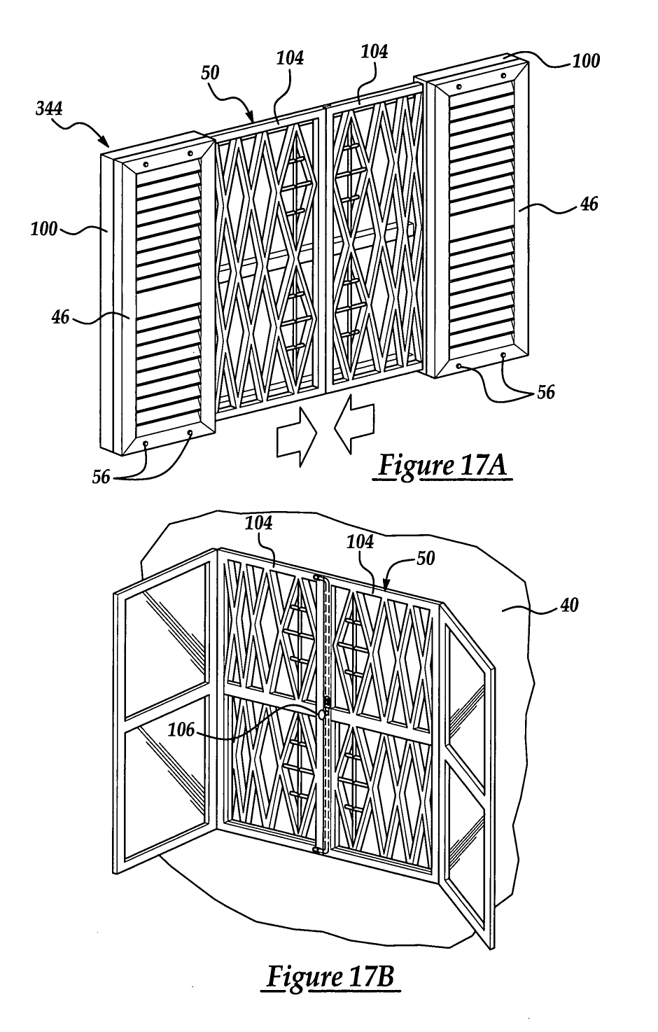

FIG. 17A illustrates a front perspective view of the shutter assembly 344 having the protective element 50 as a metal grid 104 and FIG. 17B illustrates a rear perspective view of the shutter assembly 344. It is appreciated that the grids may be made of metal, wrought iron, aluminum, steel, reinforced vinyl or other suitable materials and may be configured in decorative shapes such as squares, rectangles, balusters, turnings, etc. to create a decorative enclosure. In order to prevent entry from outside the structure 40, the protective elements 50 include a locking mechanism 106 for locking the protective elements 50 in an extended position. The locking mechanism 106 may be utilized with any type of protective element 50 to prevent access from outside the structure 40.

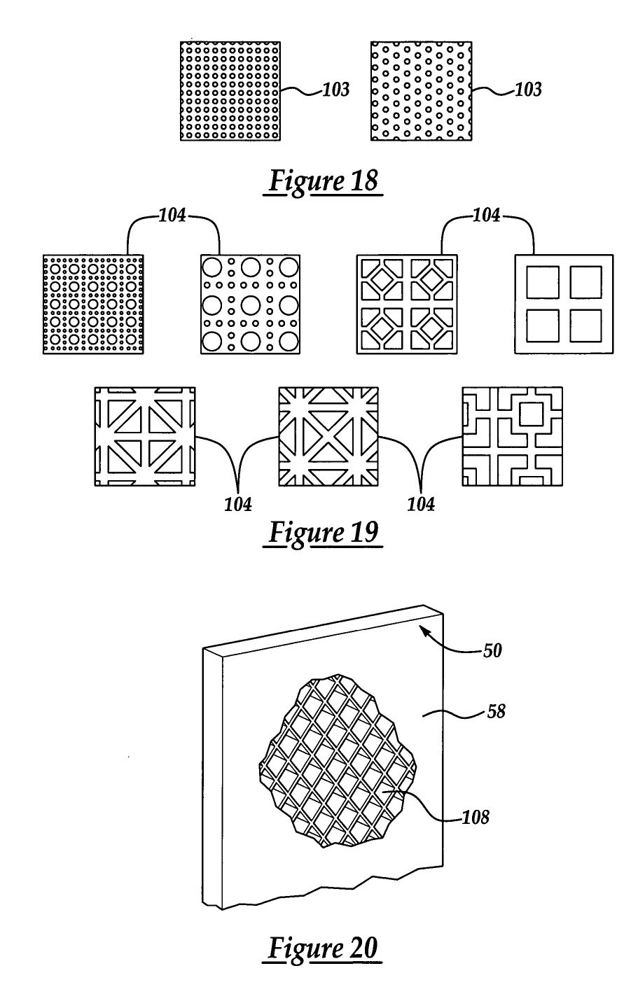

FIGS. 18 and 19 illustrate additional types of perforated 103 and decorative metal grids 104, respectively, that may be used as the protective element 50 of the subject invention. The grids or metals are utilized when the shutter assembly 344 will be primarily utilized for security protection purposes. The perforated and the metal grids 103, 104 provide an aesthetic appearance while also securing the opening 42 to prevent access from outside the structure 40. Another benefit is that the perforated and the metal grids 103, 104 may be easily opened from within the structure 40. This is especially important if there is an emergency, such as a fire, within the structure 40 and the opening 42 needs to be used as an escape route.

Referring to FIG. 20, the protective element 50 is illustrated as a hollow panel and the panel 58 is reinforced with a reinforcing material 108. In the embodiment illustrated, the reinforcing material 108 is a honeycomb shaped material. The material may be formed from either metal or plastic depending upon the amount of desired protection. The honeycomb shaped material may also have varying densities depending upon the amount of reinforcement that is desired. The protective element 50 may be solid or hollow depending upon the desired amount of protection.

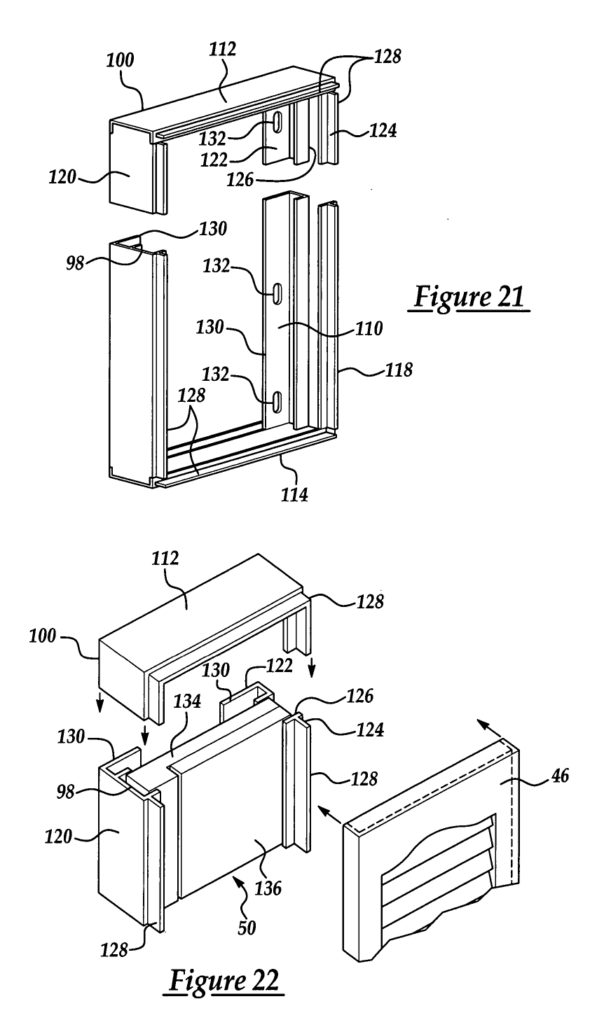

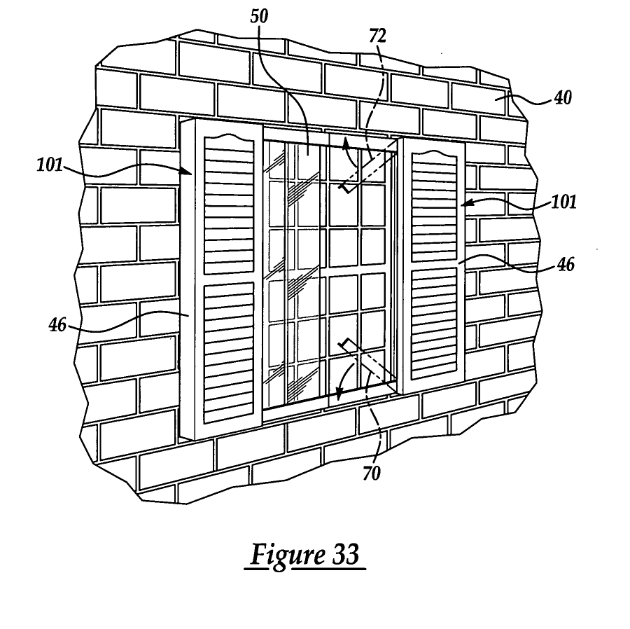

A perspective view of one housing 100 is illustrated in FIG. 21. It is to be appreciated that the pair of housings 100 are similarly shaped such that the orientation of opposite housings 100 are substantially mirror images of one another. The following description is focused on one of the housings 100 positioned to a left side of the opening 42. The housing 100 defines a cavity 110 for storing the protective element 50 therein. The housing 100 is generally formed from a top member 112, a bottom member 114, and two side members. The top member 112 and the bottom member 114 may be integrally formed or separately formed with the side members. The top member 112, the bottom member 114, and the side members may be formed from an extrusion process and may be composed from a suitable material, such as metal or plastic. It is to be appreciated that the upper and the lower tracks 70, 72 may be used with the housings 100 such that the protective element 50 is supported therein, as illustrated in FIGS. 13B and 13C. The lower track 70 may be snapped down into position prior to extending the protective elements 50. Further, the housing 100 may be integrally formed with the decorative shutter 46 as a unitary structure 101, as illustrated in FIG. 33. The unitary structure 101 may also include the upper and lower tracks 70, 72 that snap into place for receiving the protective element 50.

Referring back to FIG. 21, the side members include an inside member 118 and an outside member 120. The outside member 120 is preferably a unitary part and the inside member 118 includes a back part 122 and a front part 124 as separate units. It is to be appreciated that the inside member 118 may be formed as a unitary part. The back part 122 and the front part 124 form an element opening 126 through which the protective element 50 may extend. The top member 112, the bottom member 114, the outside member 120, and the front part 124 each include a shutter flange 128 extending along an outer periphery of the housing 100 to receive the shutter 46. If upper and lower tracks 70, 72 are used with the housing 100, then the top member 112 and the bottom member 114 cooperate with the tracks 70, 72 to facilitate the movement of the protective element 50. More specifically, the top and bottom member 112, 114 may be replaced with the tracks 70, 72 in the housing 100.

The top member 112, the bottom member 114, the outside member 120, and the back part 122 each include a mounting flange 130 that includes one or more flange slots 132 for receiving fasteners 54 for securing the housing 100 to the structure 40. The flange slots 132 may be elongated such that the position of the fasteners 54 may be adjusted. Each of the members may define element channels 98 for receiving the protective element 50. The housing 100 may be attached to the structure 40 by any other methods known to those skilled in the art without deviating from the subject invention.

Referring to FIG. 22, an exploded perspective view of an upper portion of the housing 100 is illustrated. The housing 100 preferably has the decorative shutter 46 mounted to the shutter flange 128 for concealing the cavity 110 and for providing an aesthetic appearance to the structure 40. More preferably, the decorative shutter 46 has a snap-fit connection with the housing 100 for securing the decorative shutters 46 thereto. Other well known fasteners may be used to secure the decorative shutters 46 to the housing 100, such as screws, rivets, suitable adhesives, or the like. It is to be appreciated that the decorative shutters 46 may also be fastened with the mounting system 48 described above either to the housings 100 or to the structure 40.

The protective element 50 is preferably a first set of protective elements 50 housed within one of the housings 100 and a second set of protective elements 50, identical to the first set, housed within the other of the housings 100. Preferably, each set of protective elements 50 includes a first leaf 134 and a second leaf 136. The number of leaves necessary to cover the opening 42 will be determined by the width of the opening 42 and the size of the decorative shutter 46. For example, a single panel extending from each housing 100 may be sufficient to cover the opening 42. Referring to the set of leaves 134, 136, the leaves 134, 136 extend in sliding engagement from the housing 100 in a plane offset from the opening 42 to cover the opening 42. More preferably, the leaves 134, 136 are telescopically interlocked with one another such that extending one of the leaves 134, 136 from the housing 100 results in both extending therefrom. More specifically, the first leaf 134 has an L-shaped configuration and the second leaf 136 is nested within the first leaf 134 for withdrawing the second leaf 136 from the cavity 110. It is to be appreciated that the leaves may have other configurations, such as E- or U-shaped configurations to deploy from the housing 100. The multiplicity of the leaves 134, 136 can be sized in proportion to the housing 100 while the protective element 50 still has a width sufficient to cover the opening 42. It is to be appreciated that multiple leaves 134, 136, such as two, three, or four leaves may be stored within the cavity 110 depending upon the width of the opening 42. The subject invention provides the multiple leaves stored in the housing 100 such that the decorative shutter 46 is appropriately sized for the structure 40 and the opening 42. The subject invention also retains the architectural scale of for the width of the decorative shutter 46 while still substantially covering the opening 42.

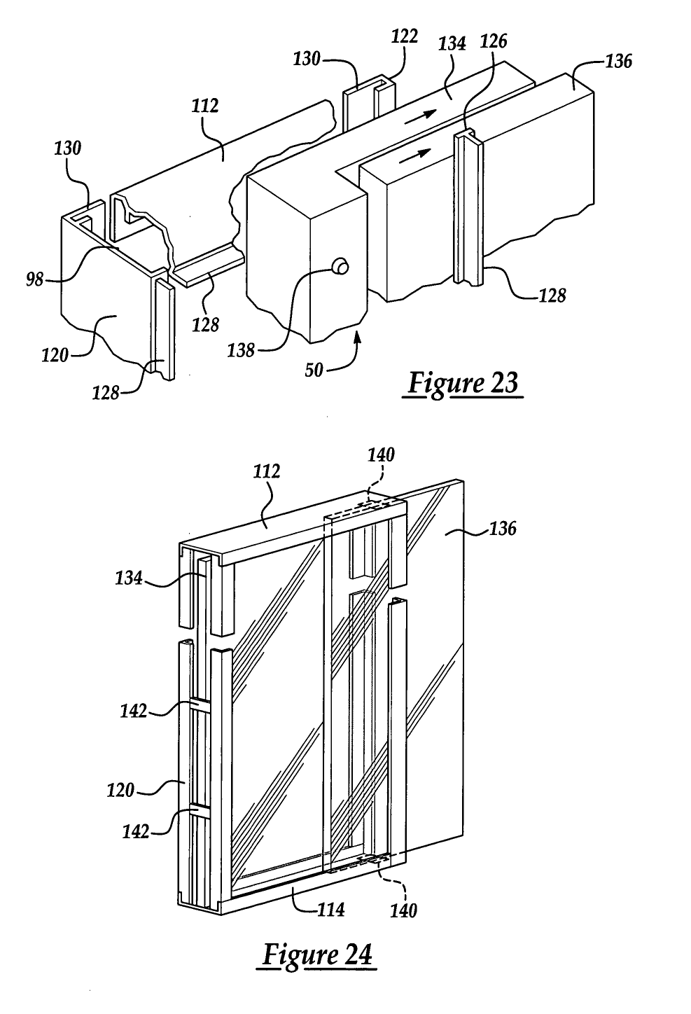

Referring to FIG. 23, the first leaf 134 includes a stop 138 for limiting movement of the leaves 134, 136. When the leaves 134, 136 are withdrawn from the cavity 110, the stop 138 will contact the inside member 118 and prevent the leaves 134, 136 from being removed. Another configuration of the protective element 50 is illustrated in FIG. 24. The first leaf 134 and the second leaf 136 are not nested together, but mounting tabs 140 interconnect the two leaves 134, 136. Also, the outside member 120 is illustrated as separate angle members having spacers 142 mounted therebetween. The spacers 142 limit the movement of the leaves 134, 136 and provide additional support to the housing 100. Additional stops or locating blocks, thumbscrews, or the like, (not shown) may restrict movement of the panels and may be mounted on the structure surface, in the tracks or on the panels to facilitate proper protection of the opening.

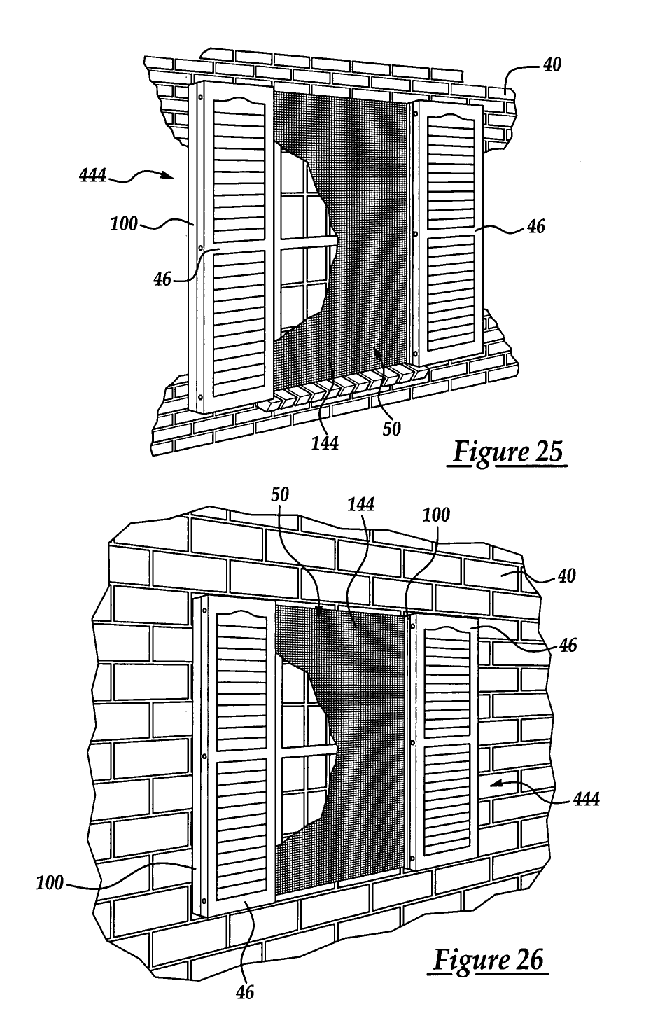

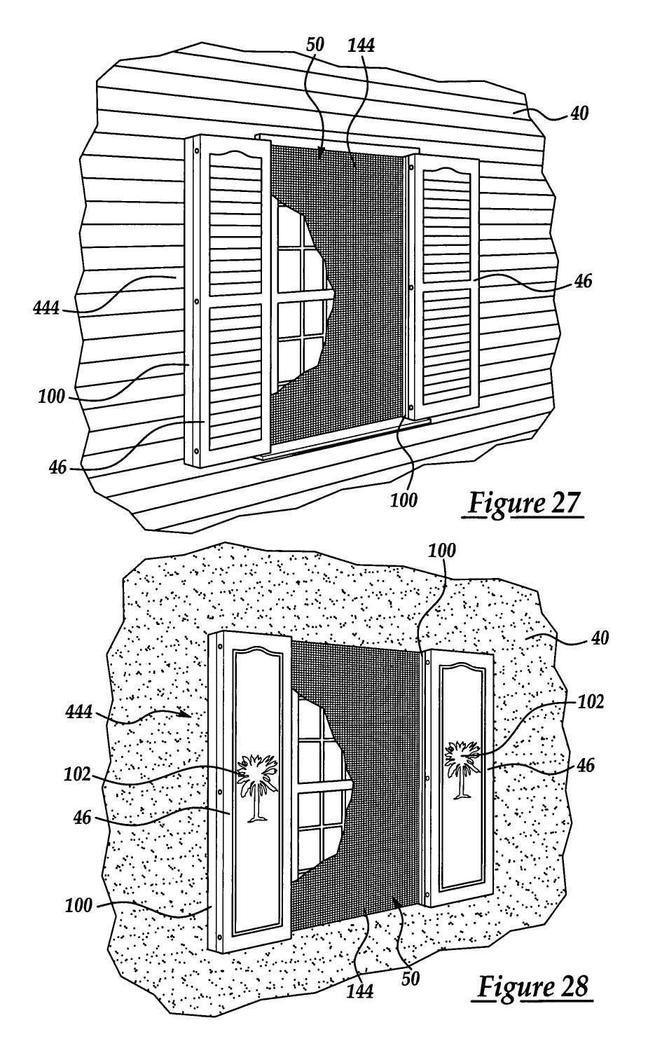

Yet another embodiment of the subject invention is illustrated in FIGS. 25 to 28. In this embodiment, a shutter assembly 444 includes the protective element 50 illustrated as a screen 144 covering the opening 42. FIG. 25 illustrates the shutter assembly 444 mounted to a brick-facade structure and FIG. 26 illustrates the shutter assembly 444 mounted to a concrete block-facade structure. FIG. 27 illustrates the shutter assembly 444 mounted to a siding-facade structure with trim abutting the assembly and FIG. 28 illustrates the shutter assembly 444 mounted to a stucco-facade structure. In FIG. 28, the decorative shutters 46 include indicia 102, such as, but not limited to, pineapples or sea horses, for improving the aesthetic appearance of the shutter assembly 444. These designs represent a coastal motif; however, traditional louver, panel, or colonial designs may also be utilized.

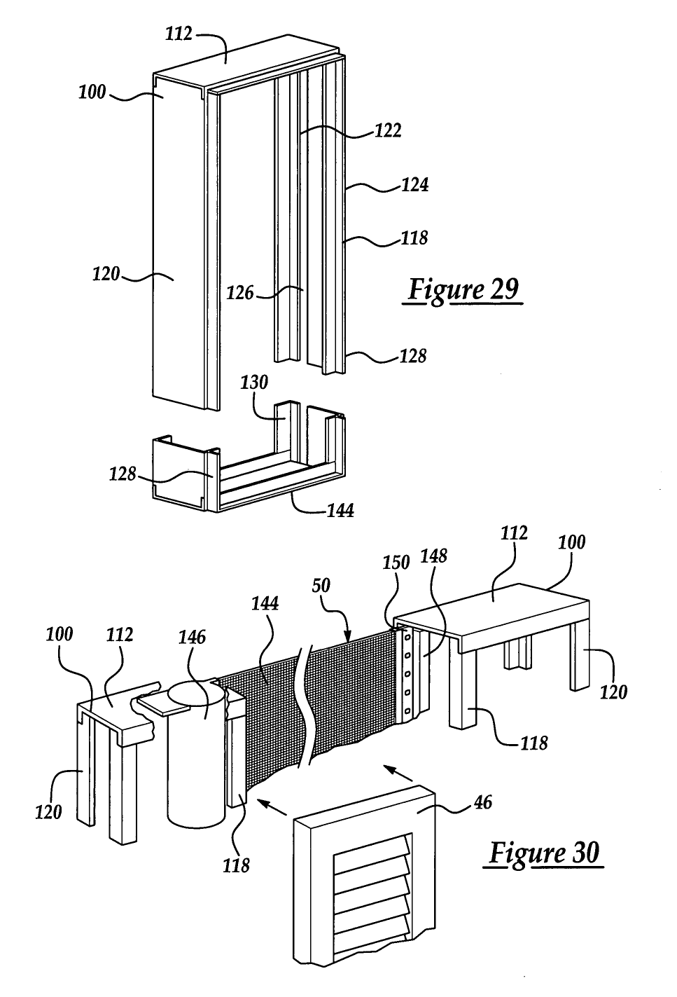

Referring to FIG. 29, one of the housings 100 is illustrated and is substantially similar to the housing 100 described above. The housing 100 is formed from the top member 112, the bottom member 114, and the two side members. The other of the housings 100 has a similar configuration; however, the screen 144 may only be positioned in one of the housings 100. With reference to FIG. 30, the shutter assembly 444 is illustrated having a screen cylinder 146 supported within one of the housings 100 for releasably storing the screen 144 about the screen cylinder 146. The screen cylinder 146 is preferably supported by the top and the bottom members 112, 114. As understood by those skilled in the art, the screen 144 may include a fine, wire mesh, a reinforced fabric, KEVLAR®, or the like for covering and protecting the opening. The other housing 100 opposite the screen cylinder 146 includes a screen-locking unit 148 for maintaining the screen 144 in the extended position. The screen 144 includes a locking edge 150 for engaging the screen-locking unit 148 and securing the screen 144 in the extended position.

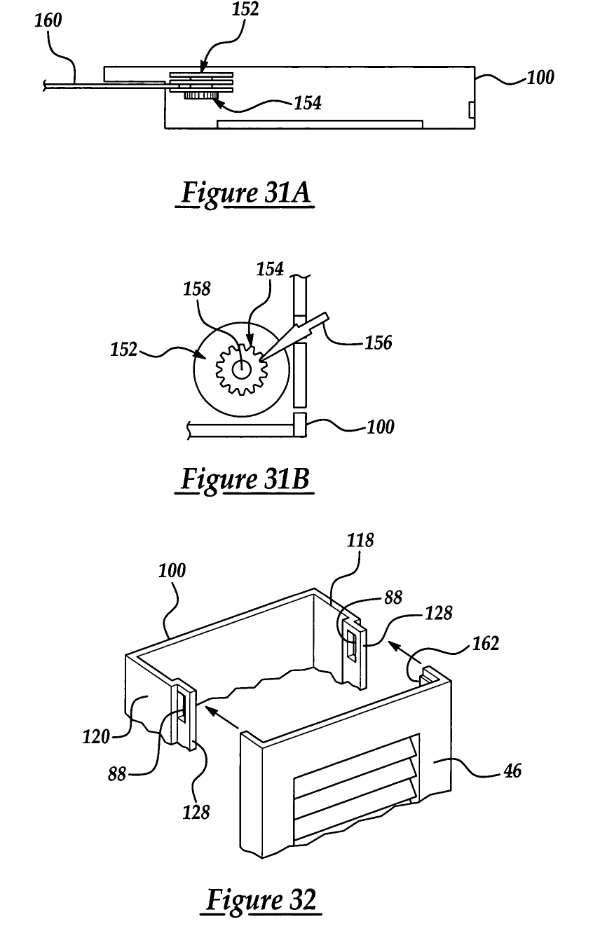

In another embodiment shown in FIGS. 31A and 31B, a reel mechanism 152 is supported in the other of the housings 100 for connecting the screen 144 thereto. The reel mechanism 152 includes a ratchet mechanism 154 and a pawl release mechanism 156 shown in FIG. 31B. A shaft 158 extends outside of the assembly to facilitate manual winding with a crank (not shown). The screen 144 includes a lower cable 160 and an upper cable (not shown) connected to the reel mechanism 152 such that screen 144 may be extended and retracted using the crank. FIG. 32 illustrates the decorative shutter 46 having a snap-fit connection with the housing 100 for enclosing the screen cylinder 146. The decorative shutter 46 includes tabs 162 and the shutter flange 128 has corresponding voids 88 for receiving the tabs 162 to create the snap-fit connection.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A shutter assembly for mounting to a structure providing storm and security protection to an opening in the structure, said assembly comprising:
a pair of housings each defining a cavity therein opposite one another for mounting to the structure adjacent the opening;
a protective element housed within at least one of said cavities for storing said protective element therein;
a pair of decorative shutters each mounted to said respective housings for concealing said cavity and for providing an aesthetic appearance to the structure; and
said protective element extending from said housing in a plane offset from the opening to cover the opening for providing storm and security protection.

2. An assembly as set forth in claim 1 further comprising a snap-fit connection between said housings and said decorative shutters for securing said decorative shutters thereto.

3. An assembly as set forth in claim 1 wherein said protective element is further defined as selected from at least one of panels, bars, grids, KEVLAR®, and screens.

4. An assembly as set forth in claim 1 wherein said protective element is further defined as at least one panel housed within said cavity for extending therefrom.

5. An assembly as set forth in claim 4 wherein said panel is further defined as a plurality of panels in sliding engagement such that each of said panels extend outwardly from said cavity.

6. An assembly as set forth in claim 5 wherein said plurality of panels telescopically interlock with one another for extending from said housing.

7. An assembly as set forth in claim 4 wherein said panel is further defined as having a reinforcing material disposed within said panel to increase strength of said panel.

8. An assembly as set forth in claim 4 wherein said panel is formed from a thermoplastic material that is translucent to allow light to pass therethrough.

9. An assembly as set forth in claim 1 wherein said protective element is further defined as a screen housed within said cavity for extending therefrom for covering the opening.

10. An assembly as set forth in claim 9 further comprising a screen cylinder supported within one of said housings for releasably storing said screen about said screen cylinder.

11. An assembly as set forth in claim 10 wherein said screen further comprises a locking edge for securing said screen in an extended position to the other of said housings.

12. An assembly as set forth in claim 10 further comprising a reel mechanism supported in the other of said housings for connecting said screen thereto such that operation of said reel mechanism tightens said screen.

13. An assembly as set forth in claim 1 further comprising a first set of protective elements housed within one of said housings and a second set of protective elements housed within the other of said housings.

14. An assembly as set forth in claim 13 further comprising a locking mechanism for locking said first and said second sets of protective elements in an extended position to cover the opening.

15. An assembly as set forth in claim 1 further comprising at least one of an upper track and a lower track extending between said housings for guiding said protective element.

16. An assembly as set forth in claim 15 further comprising a mounting assembly having inserts for mounting into the structure, fasteners formed from a non-corrosive material for engaging said inserts to mount at least one of said tracks to the structure, and plugs for insertion into said inserts to conceal said inserts within the structure.

17. An assembly as set forth in claim 15 further comprising at least one of a decorative header and a decorative sill to conceal said tracks and for improving an aesthetic appearance of the structure.

18. An assembly as set forth in claim 17 further comprising a snap-fit connection between at least one of said decorative header and said decorative sill and said tracks.

19. A hurricane protection system for mounting to a structure adjacent an opening in the structure, said system comprising:
an upper track defining a channel therein and defining holes therein for mounting to the structure above the opening;
a lower track defining a channel therein and defining holes therein for mounting to the structure below the opening;
a mounting system comprising inserts for mounting into the structure corresponding to at least one of said holes in each of said tracks, fasteners formed from a non-corrosive material inserted through said holes and into said inserts to secure said tracks to the structure, and plugs for insertion into said inserts to conceal said inserts within the structure;
a protective element slidably engaging said tracks and positioned in a plane offset from the opening for protecting the opening from debris; and
a pair of decorative window treatments secured with said fasteners to said inserts for mounting adjacent the opening to provide an aesthetic appearance to the structure.

20. A system as set forth in claim 19 wherein said protective element is further defined as having an outer periphery defining apertures for receiving said fasteners.

21. A system as set forth in claim 20 further comprising a sleeve inserted into at least one of said apertures for absorbing tension when said fasteners are secured to said inserts.

22. A system as set forth in claim 20 further comprising a frame extending about said outer periphery and inward from a plane of said protective element for contacting the structure and for creating a seal about the opening.

23. A system as set forth in claim 22 wherein said frame further comprises a vent disposed therein for releasing pressure between said protective element and the opening.

24. A system as set forth in claim 20 wherein said protective element is further defined as a thermoplastic panel having a width sufficient for enclosing the opening.

25. A system as set forth in claim 24 wherein said thermoplastic panel is further defined as formed from a polycarbonate material that is translucent to allow light to pass therethrough.

26. A system as set forth in claim 19 further comprising a pair of housings each defining a cavity therein mounted opposite one another and adjacent to the opening for storing said protective element therein.

27. A system as set forth in claim 26 further comprising a snap-fit connection between said housings and said decorative shutters for securing said decorative shutters thereto.

28. A system as set forth in claim 26 wherein said protective element is further defined as a plurality of panels in sliding engagement such that each of said panels extend outwardly from said cavity.

29. A system as set forth in claim 28 further comprising a locking mechanism for locking said plurality of panels in an extended position to cover the opening.

30. A system as set forth in claim 19 further comprising a decorative header and a decorative sill concealing said tracks and for improving an aesthetic appearance of the structure.

31. A system as set forth in claim 30 further comprising a snap-fit connection between said decorative header and said decorative sill and said tracks.

32. A system as set forth in claim 30 wherein said decorative header and said decorative sill are integrally formed with said tracks.

33. A system as set forth in claim 30 further comprising an end cap mounted to an end of each of said decorative header and said decorative sill for maintaining said protective element therein.

34. A system as set forth in claim 30 wherein at least one of said decorative header and said decorative sill further define a slot therein for receiving said fasteners and a concealing strip mountable within said slot to conceal said fasteners.

35. A system as set forth in claim 34 further comprising a snap-fit connection between said concealing strip and said channel.

36. A system as set forth in claim 19 wherein said fastener and said plug are further defined as being formed integrally with one another.

37. A hurricane protection system for mounting to a structure adjacent an opening in the structure, said system comprising:
a mounting system comprising inserts for mounting into the structure, fasteners formed from a non-corrosive material inserted into said inserts, and plugs for insertion into said inserts to conceal said inserts within the structure;
a protective element defining an outer periphery and positioned in a plane offset from the opening for protecting the opening from debris; and
a frame extending about said outer periphery and inward from a plane of said protective element for contacting the structure and for creating a seal about the opening.

38. A system as set forth in claim 37 wherein said frame further comprises a vent disposed therein for releasing pressure between said protective element and the opening.

39. A system as set forth in claim 37 further comprising a pair of decorative window treatments secured with said fasteners to said inserts for mounting adjacent the opening to provide an aesthetic appearance to the structure.

40. A system as set forth in claim 37 wherein said insert is further defined as being at least one of threaded and expandable for securing into the structure.
